(19) United States
(12) Patent Application Publication
(10) Pub. No.: US 2025/0223920 A1
(43) Pub. Date: Jul. 10, 2025

(54) EXHAUST SYSTEM FOR A GAS TURBINE ENGINE, GAS TURBINE ENGINE HAVING THE SAME, AND METHODS OF MANUFACTURING, CONFIGURING, AND USING THE SAME

(71) Applicant: DOOSAN ENERBILITY CO., LTD, Changwon-si (KR)

(72) Inventor: Alexander BOGRAD, Palm Beach Gardens, FL (US)

(21) Appl. No.: 18/406,814

(22) Filed: Jan. 8, 2024

(51) Int. Cl. F02K 1/80; F01D 25/30

(52) U.S. Cl. CPC F02C 3/32; F01D 25/30; F02K 1/80; F05D 2220/32; F05D 2230/60

(57) ABSTRACT

Exhaust systems for gas turbine engines, gas turbine engines with the same, and methods of manufacturing, configuring, and operating a gas turbine engine with an exhaust system. The exhaust system can include an inlet, an outlet, a tubular section extending between the inlet and the outlet, and a nozzle that is positioned in the tubular section. The nozzle can discharge into the flow path to produce a pressure drop. The nozzle can be a Venturi-effect nozzle. The discharge from the nozzle can reduce a pressure generated by the turbine exhaust, and by association, increase the turbine's pressure ratio and power, which can be beneficial for different operational scenarios. The exhaust system may also include a tubular section with a linear design or a non-linear design. The tubular section of the exhaust system may include at least one section with a reduced diameter, e.g., downstream of the nozzle.

### TECHNICAL FIELD

The field relates to gas turbine engines, and in particular, to exhaust systems for gas turbine engines.

### BACKGROUND

Gas turbine engines typically include a compressor, a combustor, a turbine section, and an exhaust section. The compressor supplies compressed air for cooling and for operation of the combustor. The combustor mixes the compressed air and some type of fuel and burns the mixture to generate high-temperature and high-pressure combustion gases that are then discharged into the turbine. The discharged gases then rotate turbine blades within the turbine. The rotational forces generated by the turbine blades can be used for different purposes, e.g., powering the compressor, generating electrical power, performing mechanical work, or for testing or configuring the gas turbine engine for a particular application. In some circumstances, it can be desirable to operate a gas turbine engine with a reduced turbine outlet pressure, e.g., during off-grid validation testing at pressure conditions different than current ambient pressure, or during start-up when an external device is used to supply power to the gas turbine engine to initiate rotation of the rotary shaft of the gas turbine engine. Gas turbine engines configured to readily enable the producing of such an exhaust pressure drop would be beneficial.

### SUMMARY

This summary is intended to introduce a selection of concepts in a simplified form that are further described below in the detailed description section of this disclosure. This summary is not intended to identify key or essential features of the claimed subject matter, nor is it intended to be used as an aid in isolation to determine the scope of the claimed subject matter.

In brief, and at a high level, exhaust systems for gas turbine engines, gas turbine engines having the same, and methods of manufacturing, integrating, configuring, and using the same are provided herein.

In embodiments, an exhaust system for a gas turbine engine is configured so that during operation of the gas turbine engine, a pressure drop can be induced or created in the gas turbine engine and in particular inside the exhaust system. In embodiments, a device can be incorporated into the exhaust section and operated to generate a pressure drop. In embodiments, the exhaust section can be configured in shape, profile, and/or contour to help facilitate the generation of a pressure drop. The generation of a pressure drop can be useful in numerous circumstances, e.g., it can be used for off-grid validation testing or can be used to reduce the energy required for start-up of a gas turbine engine and shorten start-up time, among other benefits. In addition, methods of manufacturing, configuring, and using an exhaust system and gas turbine engine with the same are provided.

In embodiments, an exhaust system configured to generate a pressure drop in a gas turbine engine is provided.

In some embodiments, the exhaust system can include an inlet, an outlet, and a tubular section extending between the inlet and the outlet. The inlet of the exhaust system can be attached to an outlet of the turbine of the gas turbine engine, thereby allowing exhaust gases from the turbine to be discharged through the tubular section and out of the outlet. In some embodiments, the tubular section can be linear (e.g., extend along one axis along its length) between the inlet and the outlet. In some embodiments, the tubular section can be non-linear (e.g., extend substantially along more than one axis along its length) between the inlet and the outlet, e.g., so that it can direct exhaust along a desired outflow pathway. In some embodiments, the tubular section can have a reduced diameter in certain sections along its length.

In embodiments, an exhaust system can include a nozzle positioned in the tubular section in a location and orientation that allows the nozzle during operation to discharge pressurized fluid/gas into the flow path of the exhaust system. This discharge can generate a pressure drop. In embodiments, the nozzle can be a Venturi nozzle or a non-Venturi nozzle. In embodiments, the nozzle can be attached to a fluid conduit that extends through a sidewall of the tubular section to a source of pressurized fluid/gas that during operation of the nozzle is discharged into the flow path. In embodiments, the source of pressurized fluid/gas can be compressed air. In some embodiments, the compressed air can be provided by a dedicated compressor and/or storage tank. In other embodiments, the source of pressurized fluid can be high pressure steam.

In embodiments, a gas turbine engine that is configured to generate a pressure drop therein is provided.

In embodiments, the gas turbine engine includes a compressor, a combustor, a turbine, and an exhaust system. In embodiments, the exhaust system can include an inlet, an outlet, and a tubular section extending between the inlet and the outlet. The inlet can be attached to an outlet of a turbine of the gas turbine engine allowing exhaust gases generated by the turbine to be discharged through the tubular section and through the outlet. In embodiments, the tubular section can be linear or non-linear. In embodiments, the exhaust system includes a nozzle positioned in the tubular section. The nozzle can be coupled to a fluid conduit that extends through a sidewall of the tubular section and then to a source of pressurized fluid/gas, e.g., a compressor that provides compressed air or a steam boiler that provides high pressure steam. The nozzle can be located in a position and orientation that allows the nozzle to discharge the pressurized fluid/gas into the flow path of the exhaust system, e.g., to generate a desired pressure drop during operation of the gas turbine engine.

In embodiments, a method of manufacturing an exhaust system adapted for generating a pressure drop in a gas turbine engine is provided.

In embodiments, a method of integrating an exhaust system adapted for generating a pressure drop in a gas turbine engine is provided.

In embodiments, a method of operating a gas turbine engine that includes an exhaust system as described herein is provided.

The embodiments herein directed to exhaust systems, gas turbine engines, and methods of manufacturing, integrating, and using the same can be beneficial in numerous circumstances. For example, in one instance, such embodiments can be used for off-grid validation testing where it is desirable to simulate pressure conditions that are different than ambient conditions. In another instance, such embodiments can be used during start-up of a gas turbine engine to reduce the external rotational forces required to initiate rotation of the gas turbine engine. This can decrease the time and energy required to initiate start-up and as a result help reduce emissions, among other benefits. In general, the embodiments described herein can allow for a more controlled operation of a gas turbine engine in different circumstances.

### BRIEF DESCRIPTION OF THE DRAWINGS

The present exhaust systems, gas turbine engines, and methods of manufacturing, integrating, and using the same are described in detail herein in connection with the attached drawing figures, which depict non-limiting embodiments, wherein:

FIG. 1 is a cut-away perspective view showing the internal components of a gas turbine engine, according to embodiments of the present disclosure;

FIG. 2 depicts a schematic of the gas turbine engine of FIG. 1 with an exhaust system adapted for generating a pressure drop, according to embodiments of the present disclosure;

FIG. 3 depicts a schematic of the gas turbine engine of FIG. 1 with another exhaust system adapted for generating a pressure drop, according to embodiments of the present disclosure;

FIG. 4 is a pressure diagram as it is associated with different sections of an exhaust system of a gas turbine engine, according to embodiments of the present disclosure;

FIG. 5A depicts a nozzle for an exhaust system as described herein, according to embodiments of the present disclosure;

FIG. 5B depicts a cross-section of a nozzle configured to impart a Venturi effect, according to embodiments of the present disclosure;

FIG. 6 is a block diagram of a method of manufacturing an exhaust system for a gas turbine engine, according to embodiments of the present disclosure;

FIG. 7 is a block diagram of a method of integrating an exhaust system into a gas turbine engine, according to embodiments of the present disclosure; and

FIG. 8 is a block diagram of a method of operating a gas turbine engine, e.g., having an exhaust system as described herein, according to embodiments of the present disclosure.

### DETAILED DESCRIPTION

This detailed description is provided in order to meet statutory requirements. However, this description is not intended to limit the scope of the invention described herein. Rather, the disclosed subject matter may be embodied in other ways, e.g., including different steps, different combinations of steps, different elements, and/or different combinations of elements, similar to those described in this disclosure, and in conjunction with other present or future technologies or solutions. In addition, although the terms “step” and “block” may be used herein to identify different elements of methods employed, the terms should not be interpreted as implying any particular order among or between the different elements unless the order is explicitly stated.

In general, an exhaust system that is configured to generate a pressure drop in a turbine outlet of associated gas turbine engine to facilitate certain operational functions, conditions, or effects is disclosed herein. In addition, a gas turbine engine that includes the same is disclosed herein. In addition, methods of manufacturing the exhaust systems and gas turbine engines described herein are provided, as are methods of integrating the exhaust systems described herein into a gas turbine engine; and methods of operating a gas turbine engine with the exhaust systems described herein.

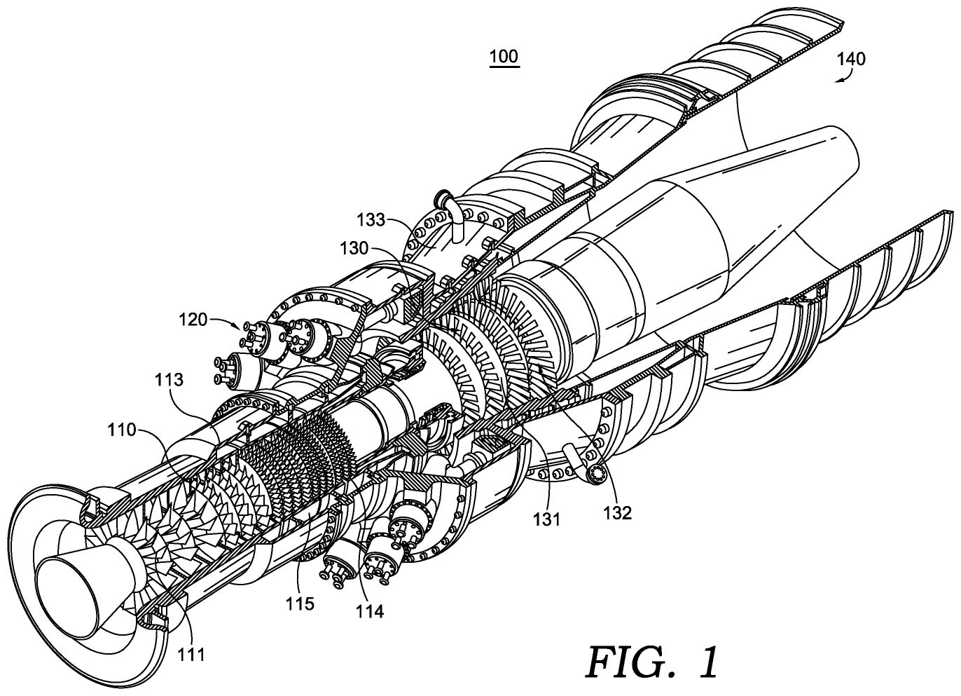

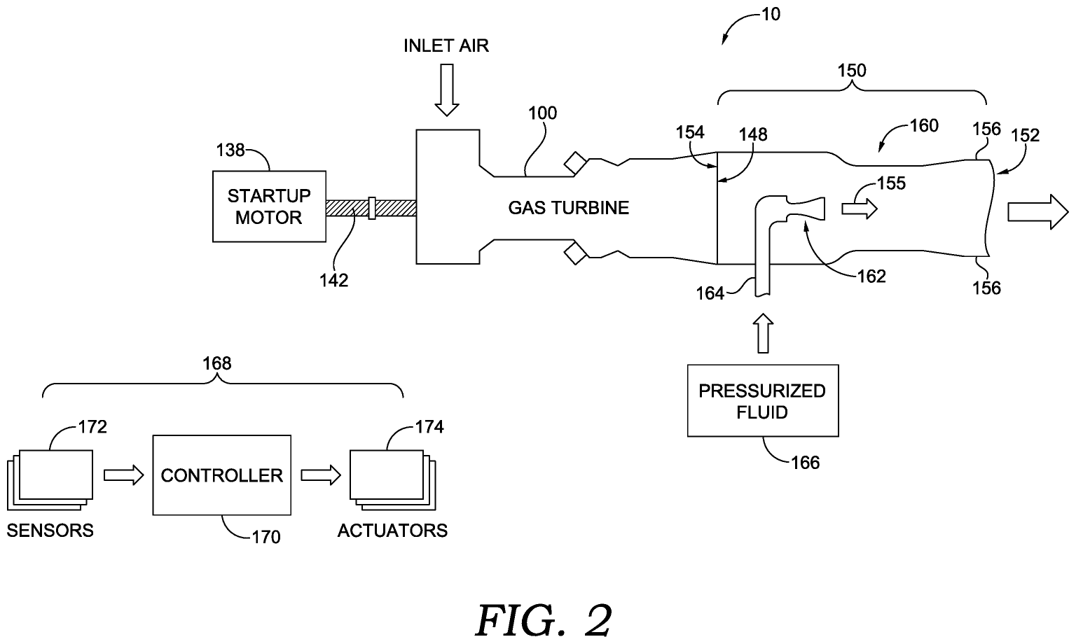

Hereinafter, a gas turbine engine will be described. FIG. 1 is a cut-away perspective view showing an internal configuration of a gas turbine engine 100, according to embodiments of the present disclosure. FIG. 2 is a schematic of the gas turbine engine 100 with an exhaust system adapted for generating a pressure drop, according to embodiments of the present disclosure. The thermodynamic cycle used by the gas turbine engine 100 may be a Brayton cycle. The Brayton cycle has four phases, including isentropic compression (adiabatic compression), isobaric heat addition, isentropic expansion (adiabatic expansion), and isobaric heat dissipation. During the Brayton cycle, thermal energy is released through the combustion of fuel in an isobaric environment after atmospheric air is sucked in and compressed to a high pressure; hot combustion gases are expanded to be converted into kinetic energy; and exhaust gases with residual energy may then be discharged into the external atmosphere. To state it differently, the Brayton cycle may include four processes referred to as compression, heating, expansion, and exhaust.

The gas turbine engine 100 includes a compressor 110, a plurality of combustors 120, and a turbine 130, as identified in FIG. 1. While the following description is provided in connection with the embodiment of FIG. 1, the subject matter and improvements described herein can be widely applied across turbine engines of various configurations. In other words, the subject matter and improvements described herein can be applied to turbine engines of a range of possible configurations and applications (e.g., generation of electrical power; power generation for ships, aircraft, or other industrial applications; and/or performing various types of mechanical work, among other things).

Looking still at FIG. 1, it can be seen that the compressor 110 of the gas turbine engine 100 is configured to intake air from the external environment and compress the air so that higher-pressure air can then be introduced into other parts of the gas turbine engine 100, e.g., to be used for combustion, cooling, or other functions. In embodiments, air sucked into the compressor 110 is subject to an adiabatic compression process, and as a result, the pressure and temperature of the air that has passed through the compressor 110 increases. The compressor 110 supplies the combustors 120 with compressed air provided via rotating compressor blades 113. The compressor 110 can also supply compressed air to certain parts of the gas turbine engine 100 to help with cooling those parts of the gas turbine engine 100 during operation thereof.

The compressor 110 can have different configurations. For example, in embodiments, the compressor 110 can be a centrifugal compressor or can be an axial compressor. In general, a centrifugal compressor can be used in a smaller gas turbine engine, and a multistage axial compressor can be used in a larger gas turbine engine, e.g., the engine 100 shown in FIG. 1, because the latter is suitable for compressing a larger amount of air. During operation, the compressor blades 113 of the compressor 110 rotate along with the rotation of rotor disks to compress air introduced therein while delivering the compressed air to rear-stage compressor vanes 114. The air is compressed increasingly to a higher pressure while passing through the compressor blades 113 which, are assembled in a multistage fashion as shown in the example of FIG. 1.

FIG. 1 shows how a plurality of compressor vanes can be arranged in a multistage configuration and mounted in a compressor casing 115. The compressor vanes can help guide the compressed air that flows from front-stage compressor blades 113 to rear-stage compressor blades 114. In some embodiments, at least some of the plurality of compressor vanes may be mounted so as to be rotatable within a fixed range to thereby help regulate the inflow rate of air.

The compressor 110 can be driven by some of the power output from the turbine 130. For example, a rotary shaft of the compressor 110 may be directly connected to the rotary shaft of the turbine 130, as illustrated in FIG. 1. In a larger gas turbine engine, e.g., the gas turbine engine 100, the compressor 110 may use almost half of the power generated by the turbine 130 to drive the compressor 110.

The turbine 130 includes a plurality of rotor disks 131, a plurality of turbine blades 133 radially arranged on each of the rotor disks 131, and a plurality of turbine vanes (not depicted). Each of the rotor disks 131 has a substantially disk-like shape and can have a plurality of grooves formed on the outer peripheral portion thereof. The grooves can have a curved surface so that the turbine blades 133 can be inserted into the grooves. The turbine vanes can be mounted to the turbine casing. The turbine vanes can be fixed so as not to rotate, and thereby help guide the direction of flow of the hot combustion gases passing through the turbine blades 133. The turbine blades 133 that are rotated by the hot combustion gases create rotational force that can be used for different purposes, e.g., generation of electrical power or performing mechanical work.

The combustors 120 are each configured to mix compressed air, which is supplied via the outlet of the compressor 110 with fuel (e.g., hydrogen gas, natural gas, or another fuel) for isobaric combustion, which produces combustion gases with high energy that are then discharged across the turbine blades 133 to cause rotation thereof. Each combustor 120 is disposed downstream of the compressor 110 and is arranged annularly around a central axis of the gas turbine engine 100, as shown in FIG. 1.

Looking now at FIG. 2, a schematic of a system 10 that includes a gas turbine engine 100 with an exhaust system adapted to generate a pressure drop in the turbine outlet 154 is provided, according to embodiments of the present disclosure. FIG. 2 shows a start-up motor 138 attached to the gas turbine engine 100. In particular, the start-up motor 138 may be attached to a rotary shaft 142 that is coupled to and extends through the gas turbine engine 100. The start-up motor 138 can be used to power rotation of the gas turbine engine 100 during its start-up process. The gas turbine engine 100, once at a self-sustaining operating condition, independently turns the rotary shaft 142 and the start-up motor 138 can cease operating. The gas turbine engine 100 can be attached to an electrical generator, machine, or other system so that power generated by the gas turbine engine 100 can be used.

The gas turbine engine 100 includes an exhaust system 160 that is adapted so that it can modify operating characteristics of the gas turbine engine 100. In particular, the exhaust system 160 can be controlled to generate a pressure drop in the turbine outlet 154. The exhaust system 160 includes an inlet 148, an outlet 152, and a tubular section 150 that extends between the inlet 148 and the outlet 152. The tubular section 150 includes a sidewall 156 that encloses and directs exhaust gases towards the outlet 152. The inlet 148 of the exhaust system 160 is attached to a turbine outlet 154. During operation of the gas turbine engine 100, hot combustion gases discharged from the turbine section pass through the turbine outlet 154 and through the inlet 148 of the exhaust system 160. The combustion gases then pass through the tubular section 150 to the outlet 152 where the combustion gases are then discharged into the external atmosphere.

To initially operate the gas turbine engine 100, a start-up process is performed. The start-up process can present particular challenges, e.g., overcoming static resistance forces to initiate rotation of the rotary shaft 142 (which may be coupled to the rotor disks 111 of the compressor 110 and the rotor disks 131 of the turbine 130). During start-up, the rotary shaft 142 of the gas turbine engine 100 accelerates due to the excess power generated by gas turbine engine 100 and the starter motor 138 in excess of the power required to rotate the compressor and overcome other resistance forces of the gas turbine engine 100. The power developed by the gas turbine engine 100 depends on a number of factors, including the temperature of gases at the inlet of the gas turbine engine 100, the expansion ratio of the gases within the gas turbine engine 100, the temperature of different structures of the gas turbine engine, among other factors. There are additional limitations on the power of the starter motor 138. The time and efficiency of a start-up process can be impacted by these factors. Reducing start-up time can be important for operational performance, operational availability, and for reducing or limiting emissions. However, start-up processes are typically limited by the available turbine/starter motor power.

The exhaust system 160 is adapted so that a pressure drop can be generated in the exhaust system 160 and thus in the gas turbine engine 100 during operation thereof, e.g., during a start-up process, as described above. In particular, the exhaust system 160 is configured to increase the turbine pressure ratio and thus the power output by the gas turbine 130. This in turn can help reduce the time and energy required for the gas turbine engine 100 to complete a start-up process. It can also reduce the power input required from an external device, e.g., the starter motor 138, or another machine. The generation of a pressure drop can also allow for increased power output from the gas turbine engine 100 at peak loads, and in particular, in conditions with higher ambient temperatures.

To generate a pressure drop in the exhaust system 160 and thus also in the turbine 130, the exhaust system 160 includes a nozzle 162 that is positioned and oriented to introduce a pressurized fluid/gas into a flow path 155. The introduction of pressurized fluid/gas causes a pressure reduction in the exhaust system 160. The nozzle 162 is connected to a fluid conduit 164, as shown in FIG. 2. The fluid conduit 164 extends to a source of pressurized fluid 166 that can be external to the exhaust system 160. In some embodiments, the pressurized fluid can be compressed/pressurized air. The compressed/pressurized air can be provided by a compressor, e.g., a dedicated compressor, or by the compressor 110 in FIG. 1 that provides compressed air to different components of the gas turbine engine 100, and/or can be provided from one or more pressurized storage tank(s). In some embodiments, the pressurized fluid/gas can be pressurized steam.

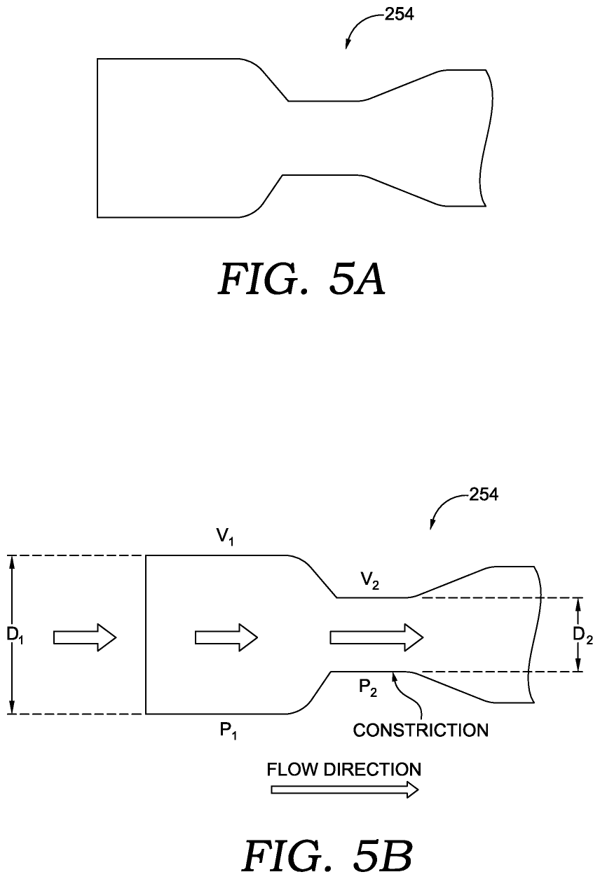

FIG. 2 shows how the nozzle 162 is positioned inside the tubular section 150 of the exhaust system 160. To support this position, the fluid conduit 164 extends from the source of pressurized fluid 166, through the sidewall 156 of the tubular section 150, and then into a central portion of the tubular section 150. To allow the pressurized fluid to be introduced in the direction of the flow path 155, the nozzle 162 is oriented generally perpendicular to the fluid conduit 164 so that discharge from the nozzle 162 is generally directed along the axial direction of the flow path 155. To control introduction of the pressurized fluid, a valve (not shown) can be included in the fluid conduit 164 and operated to control the flow of pressurized fluid. In addition, as shown in FIG. 2, a control system 168 can be communicatively connected to different components that control operation of the nozzle 162. The control system 168 includes a controller 170 that can have one or more processors and/or one or more memories for storing computer-readable instructions that can be read and executed by the processor(s). The control system 168 can include one or more sensors 172 that provide feedback signals to the controller 170 (e.g., related to pressure, temperature, rotational speed of the turbine, or the like). The control system 168 can also be connected to one or more actuators 174 that can be operated by the controller 170 to affect operations of the gas turbine engine 100, nozzle 162, or source of pressurized fluid 166, among other things. For example, this can include opening or closing valves or valve assemblies to control discharge of a pressurized fluid from the nozzle 162. In some embodiments, the nozzle 162 is a Venturi-effect nozzle, or rather, is shaped so that a constriction in diameter within the nozzle accelerates a fluid passing through and ejected from the nozzle 162. FIG. 5A depicts one non-limiting example of such a nozzle.

The exhaust system 160 and gas turbine engine 100 shown in FIG. 2 represents one example configuration that can allow for generation of a pressure drop within the exhaust system 160 that can provide the benefits described in the preceding sections, e.g., reduce exhaust pressure, increase the turbine pressure ratio, increase turbine power output, reduce the power and/or time required to perform start-up of the gas turbine engine 100, and/or increase the power of the gas turbine engine 100 during peak loads and/or output, among other benefits.

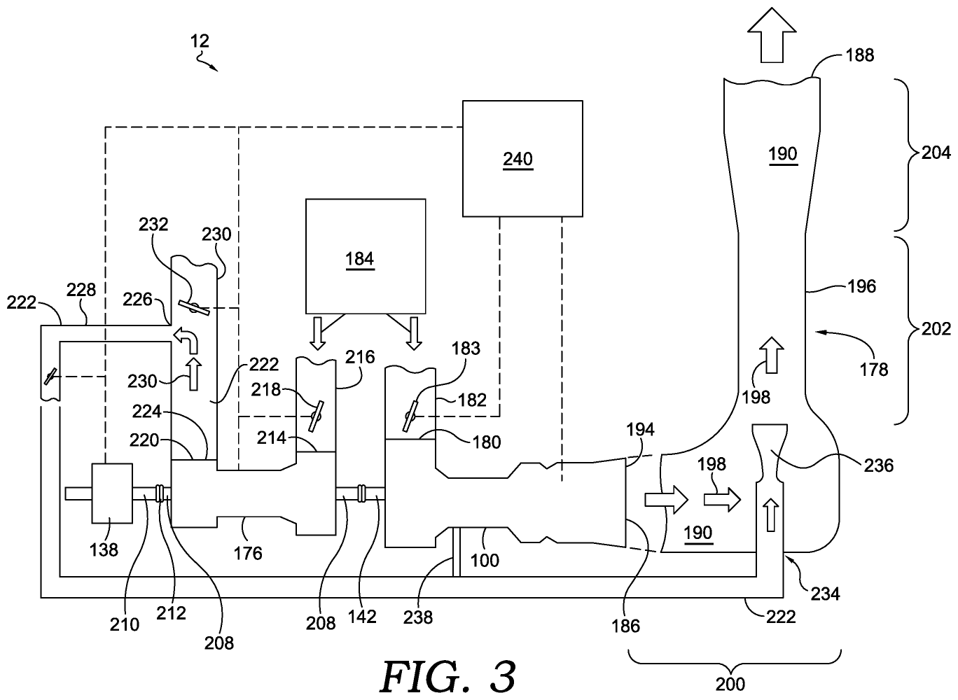

FIG. 2 depicts the exhaust system 160 with a linear configuration. However, in embodiments, the exhaust system 160 may instead have a non-linear configuration, e.g., extend along two or more axial directions instead of a single axial direction as shown in FIG. 2. In some embodiments, the nozzle 162 can be used in connection with a start-up process for the gas turbine engine 100 and the exhaust system 160, e.g., as provided in FIG. 2. In other embodiments, the nozzle 162 can be used in connection with off-grid validation testing of the gas turbine engine 100 and the exhaust system 160, e.g., similar to that provided in FIG. 3. In embodiments, the nozzle 162 can be used in other circumstances, e.g., in connection with peak loads and/or output of the gas turbine engine 100.

Looking now at FIG. 3, a schematic of a system 12 that includes the gas turbine engine 100 with another exhaust system 178 adapted to generate a pressure drop is provided, according to embodiments of the present disclosure. The system 12 is similar to the system 10 shown in FIG. 2. However, the system 12 in FIG. 3 is provided with a different configuration, and in particular, one suitable for off-grid validation testing or other testing processes.

The system 12 includes the gas turbine engine 100 that can be operated for off-grid testing. The gas turbine engine 100 is rotationally coupled to a load compressor 176 at one end of the gas turbine engine 100 and is coupled to the exhaust system 178 at the other end of the gas turbine engine 100. The gas turbine engine 100 includes an air intake 182 where air can be introduced into the compressor section of the gas turbine engine 100. The air intake 182 is coupled to an air source 184, which can be a filtration enclosure that supplies air into the air intake 182. In addition, an air intake throttle 183 is positioned in the air intake 182 and is operable to control a pressure and mass flow rate of the air passing through the air intake 182 into the compressor section of the gas turbine engine 100.

The exhaust system 178 includes an inlet 186, an outlet 188, and a tubular section 190 that extends between the inlet 186 and the outlet 188. In addition, the gas turbine engine 100 includes a turbine outlet 194 that is coupled to the inlet 186 of the exhaust system 178. The tubular section 190 includes a sidewall 196 that encloses and directs hot combustion gases along a flow path 198 through the exhaust system 178 to the outlet 188, where the hot combustion gases may be discharged into the external atmosphere.

The system 10 can be configured so that the tubular section 150 is generally linear, or rather, the flow path is linear. In FIG. 3, the system 12 is configured so that the tubular section 190 is non-linear, or rather, has at least one change of direction, or rather, extends in more than one axial direction. In the example of FIG. 3, the tubular section 190 includes a 90-degree turn, such that parts of the tubular section 190 and flow path 198 are perpendicular to each other. This can allow for discharging exhaust gases in a desired direction and modification of other flow characteristics within the exhaust system 178. The tubular section 190 includes a lengthwise section 200 extending from the inlet 186 (linearly), a lengthwise section 202 extending from the lengthwise section 200 (perpendicularly), and a lengthwise section 204 extending from the lengthwise section 202 (linearly) to the outlet 188. The lengthwise sections 200 and 202 are approximately perpendicular to each other. The lengthwise section 202 has a reduced or constricted diameter compared to the lengthwise section 200. The lengthwise section 204 has an expanding diameter compared to the lengthwise section 202. This configuration provides different benefits, including accelerating the flow of hot combustion gases through the tubular section 190, which can help prevent backflow and turbulence. FIG. 3 shows one perpendicular transition. However, one or more transitions of the same or different angles can also be incorporated into an exhaust system in other embodiments contemplated herein.

Looking still at FIG. 3, the rotary shaft 142 extends from the gas turbine engine 100 to the load compressor 176. The rotary shaft 142 is mechanically coupled to a rotary shaft 208 that extends through the load compressor 176. This allows the rotary shafts 142 and 208 to rotate together during operation of the gas turbine engine 100. In addition, the system 12 includes a starter motor 138 with a rotary shaft 210. The rotary shaft 210 is mechanically coupled to the rotary shaft 208. This allows, e.g., during a start-up process, the rotary shafts 142, 208, and 210 to rotate together about a common axis, in accordance with some aspects. In embodiments, the starter motor 138 can be releasably or detachably attached to the rotary shafts 142 and 208. In some embodiments, a torque converter, a gearbox, or a combination thereof may be interposed between the rotary shafts 142, 208, and/or 210 so that rotational forces transferred between the elements 100, 176, and 138 can be modified. In embodiments, rotary shafts described herein that are used to connect different elements, e.g., 100, 176, and 138, may be integrally formed as one unitary rotary shaft, or can be formed as separate rotary shafts that are attached together, e.g., with mechanical connections that allow them to rotate in unison, and that can be decoupled to allow for separate rotation.

The load compressor 176 includes an inlet 214 that is coupled to an air source (e.g., the air source 184), which can supply air through an air intake 216. The pressure and mass flow rate of the air introduced from the air source 184 into the air intake 216 can be controlled by a throttle 218 positioned in the air intake 216. The throttle 218 may be used during start-up to control the flow through the load compressor 176. The throttles 183 and 218 can be valves, louvers, or other adjustable flow-regulating mechanisms. The load compressor 176 also includes an outlet 220 that is attached to a fluid conduit 222. The fluid conduit 222 includes an end 224 that is connected to the outlet 220 and a junction 226 that is downstream from the end 224 where the fluid conduit 222 splits into a fluid pathway 228 to the exhaust system 178 and a fluid pathway 230 that extends to a discharge outlet to the external atmosphere (not depicted in FIG. 3). Located at or adjacent to the junction 226 is a bypass throttle 232 that can be operated to adjust the pressure and mass flow rate through the load compressor 176 during operation after start-up.

In the embodiment of FIG. 3, the fluid conduit 222 extends along the fluid pathway 228 to the exhaust system 178. The fluid conduit 222, in particular, extends through the sidewall 196 of the tubular section 190 of the exhaust system 178. In particular, the fluid conduit 222 extends through the sidewall 196 at a location 234 generally adjacent to the intersection of the lengthwise sections 200 and 202. The fluid conduit 222 extends through the sidewall 196 at the location 234 and terminates at a nozzle 236. The nozzle 236 can be similar to the nozzle 162 described in connection with FIG. 2, e.g., can be a Venturi-effect nozzle or other nozzle that is designed to accelerate the flow of fluid passing through it. In the system 12, the nozzle 236 is positioned such that it extends along a common axial direction as the fluid conduit 222, based on the directionality of the tubular section 190 and position of the location 234, as shown in FIG. 3, and in contrast to the nozzle 162 that is oriented orthogonally.

The nozzle 236 can be used to discharge pressurized fluid/gas, e.g., compressed air, supplied from the load compressor 176 through the conduit 222 into the tubular section 190 of the exhaust system 178. This discharge into the flow path 198 of the tubular section 190 can produce a pressure drop that can be used for the benefits described herein. During operation, the energy consumed by the load compressor 176 can be converted into the energy of compressed and heated air. Thus, by directing some or all of this compressed and heated air ejected from the load compressor 176 through the nozzle 236 and into the flow path 198 of the exhaust system 178 instead of out to the external environment through another path, a reduction in the pressure can be produced downstream of the gas turbine engine 100. In addition to causing this pressure drop, the inlet throttle 183 can be used to control the pressure and/or mass flow rate of the air entering the compressor section 110 of the gas turbine engine 100, e.g., by approximately the same degree as that occurring in the exhaust system 178 through discharge from the nozzle 236. This allows each of the components of the gas turbine engine 100 to operate at similar design or test conditions. This, in turn, enables the creation of simulated operating conditions for checking the operation of the gas turbine engine 100 under approximately the same operating conditions as actual intended use. The configuration of the exhaust system 178 and nozzle 236 also expands the maximum possible operating range or adjustments possible for testing.

In the embodiment of FIG. 3, the air supplied into the flow path 198 through the nozzle 236 is provided by the load compressor 176. However, in other embodiments, in addition or in the alternative, compressed air can be supplied from the compressor 110 of the gas turbine engine 100 to the nozzle 236, e.g., through a conduit 238 that connects to the fluid conduit 222 as shown in FIG. 3. In embodiments, the compressor 110 may supply some or all of the compressed air that is discharged into the flow path 198 through the nozzle 236. In embodiments, there may be a valve interposed between the conduit 238 and the conduit 222 that can be operated so that compressed air is supplied from either or both sources to the nozzle 236.

The system 12 further includes a control system 240. The control system 240 can be similar in configuration and operation as the control system 168 shown in FIG. 2, and thus is provided in generic form in FIG. 3 for clarity. The control system 240 can be communicatively connected to different elements of the system 12, e.g., throttles 183, 218, and 232, starter motor 138, load compressor 176, and/or the gas turbine engine 100, among other elements such as sensors and actuators associated with the same. Through these connections, the control system 240 can control operation of elements of the system 12, e.g., to facilitate engine start-up as described herein, and/or to facilitate simulated operating conditions for validating testing, or for other reasons.

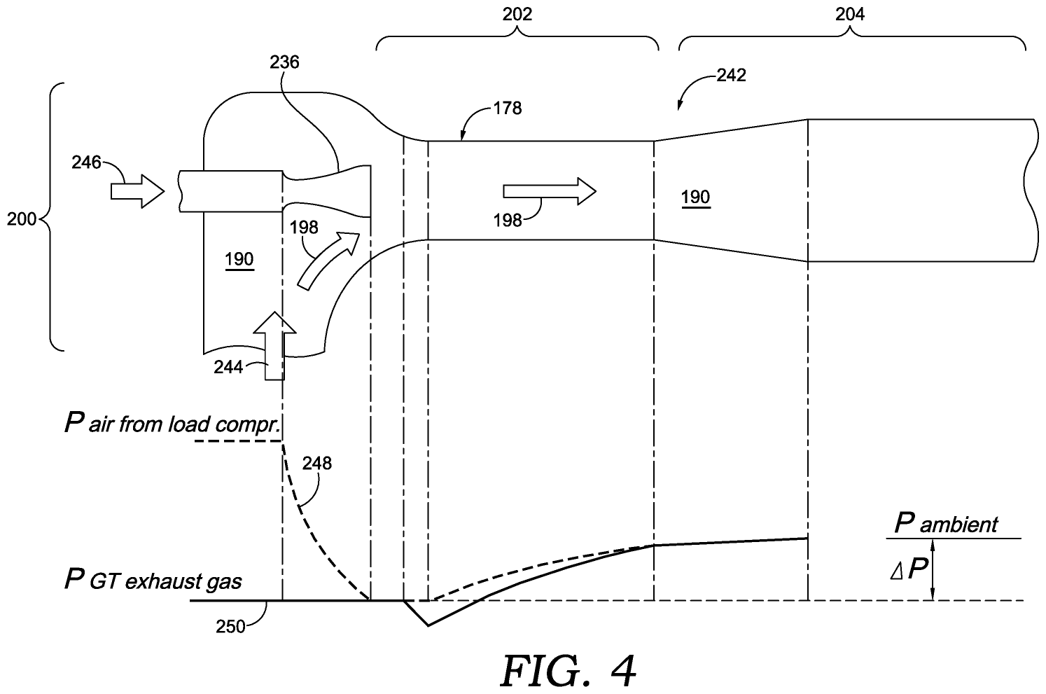

Looking now at FIG. 4, a pressure diagram 242 that depicts pressures associated with different parts of the exhaust system 178 used by the gas turbine engine 100 in FIG. 3 is provided, according to embodiments of the present disclosure. During operation, hot combustion gases 244 are discharged from the turbine 130 into the flow path 198 of the exhaust system 178, as shown in FIG. 4. The nozzle 236 is positioned in the tubular section 190. This allows the nozzle 236 to discharge pressurized fluid/gas 246, e.g., supplied from the load compressor 176 as referred to in FIG. 4, into the tubular section 190. The introduction of the pressurized fluid/gas 246 in combination with the hot combustion gases 244 passing through the tubular section 190 generates a pressure reduction in the system 12 of FIG. 3. This pressure reduction can be controlled to a degree by the pressure and volumetric flow rate of the discharge from the nozzle 236. FIG. 4 also shows the lengthwise sections 200, 202, and 204 of the tubular section 190. In FIG. 4, it can be seen that the lengthwise section 202 has a length along which the diameter is reduced or constricted relative to the lengthwise sections 200 and 204. This diameter constriction can help accelerate the flow of the fluid and gases 244 and 246 and thus, like the nozzle 236, help facilitate a pressure drop.

FIG. 4 shows with the dotted line 248 the pressure of the pressurized fluid/gas 246 supplied from the load compressor 176 at points along the tubular section 190/flow path 198. The solid line 250 shows the pressure of the exhaust gases 244 supplied from the turbine outlet into the tubular section 190 at points along the tubular section 190/flow path 198. FIG. 4 depicts how the exhaust gases 244 are initially at a pressure below ambient pressure (P_{AMBIENT}), and then transition to a lower pressure in the part of the tubular section 190 immediately subsequent to the nozzle 236 where the pressurized fluid/gas 246 is introduced into the flow path 198. Then, the pressure of the exhaust gases 244 increases to approximately the ambient pressure (P_{AMBIENT}) through the lengthwise sections 202 and 204. FIG. 4 also depicts how the pressurized fluid/gas 246 is supplied into the nozzle 236 at a pressure initially higher than ambient pressure (P_{AMBIENT}), and then the pressure drops as the pressurized fluid/gas 246 passes through the nozzle 236 to a pressure (P_{Δ}) below ambient pressure (P_{AMBIENT}). The pressurized fluid/gas 246 passing through the lengthwise section 202 with a reduced diameter increases in pressure until it is substantially the same as the pressure of the exhaust gases 244 at the expansion section 252 of the tubular section 190 where the diameter of the tubular section increases, as shown in FIG. 4.

Looking now at FIG. 5A, a nozzle 254 that can form part of an exhaust system, e.g., the exhaust systems 160 and 178 shown in FIGS. 2 and 3 herein, is provided, according to embodiments of the present disclosure. The nozzle 254 is shaped such that it is a Venturi-effect nozzle. In a Venturi-effect nozzle, as the diameter of the nozzle changes, the pressure and velocity of the fluid passing through the nozzle changes. For example, if the diameter is larger, the pressure is higher, and the velocity of the fluid passing through the nozzle is lower; and, if the diameter of the nozzle is smaller, the pressure of the fluid passing through the nozzle is lower, and the velocity of the fluid passing through the nozzle is higher. Passing a fluid such as compressed air through a Venturi-effect nozzle results in the fluid passing through a point of constriction that reduces the pressure and accelerates the velocity of the fluid. FIG. 5B depicts a cross-section of the Venturi-effect nozzle 254 showing how fluid (e.g., compressed air) entering the upstream end of the nozzle 254 has a first pressure (P₁) and a first velocity (V₁) associated with a first section of the nozzle 254 that has a first diameter (D₁), and then the fluid (e.g., compressed air) passes through a constriction where the fluid has a second pressure (P₂) that is lower than the first pressure (P₁) and a second velocity (V₂) that is higher than the first velocity (V₁) along a second section of the nozzle that has a smaller diameter (D₂).

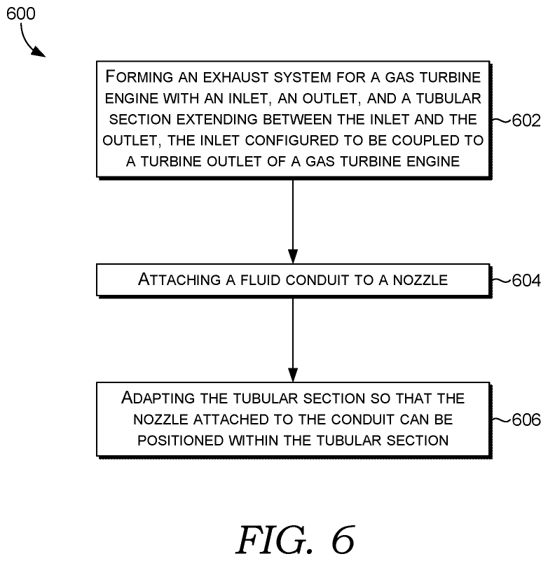

Looking now at FIG. 6, a block diagram of a method 600 of manufacturing an exhaust system, e.g., either of the exhaust systems 160 and 178 shown in FIGS. 2 and 3, for a gas turbine engine, e.g., the gas turbine engine 100 shown in FIG. 1, is provided, according to embodiments of the present disclosure. The method 600 includes blocks 602-606, but is not limited to this selection of elements or the order depicted. In block 602, the method 600 includes forming an exhaust system for a gas turbine engine with an inlet, an outlet, and a tubular section extending between the inlet and the outlet, the inlet configured to be coupled to a turbine outlet of a gas turbine engine. In embodiments, the exhaust system can be the exhaust system 160 in FIG. 2, such that the inlet is the inlet 148 in FIG. 2, the outlet is the outlet 152 in FIG. 2, and the tubular section is the tubular section 150 in FIG. 2. In block 604, the method 600 includes attaching a fluid conduit, e.g., the fluid conduit 164 shown in FIG. 2, to a nozzle, e.g., the nozzle 162 shown in FIG. 2. In block 606, the method 600 includes adapting the tubular section so that the nozzle attached to the conduit can be positioned within the tubular section, e.g., as shown in FIG. 2 or in FIG. 3 or in accordance with another configuration described herein. The nozzle, conduit, and/or other associated components can be configured such that a stream of pressurized fluid/gas can be selectively introduced into the flow path of the exhaust system to thereby generate a pressure drop in the exhaust system that can be used for the purposes described herein.

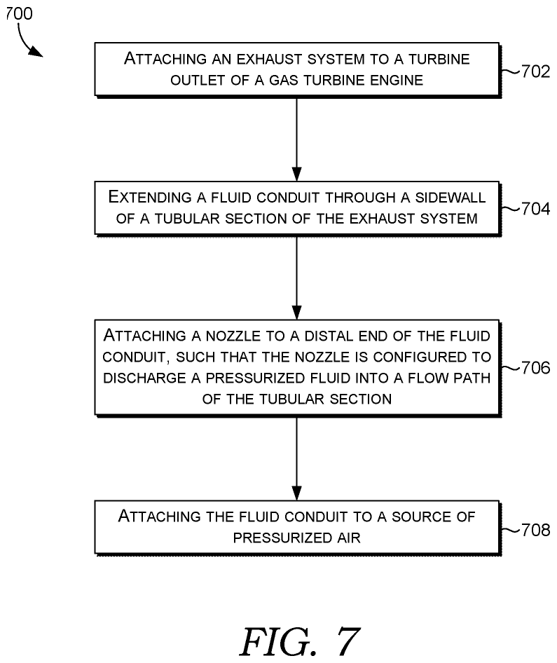

Looking now at FIG. 7, a block diagram of a method 700 of modifying an exhaust system of a gas turbine engine, e.g., the gas turbine engine 100 shown in FIG. 1, is provided, according to embodiments of the present disclosure. The method 700 includes blocks 702-708, but is not limited to this selection of elements or the order depicted. In block 702, the method 700 includes attaching an exhaust system, e.g., the exhaust system 160 shown in FIG. 2 or the exhaust system 178 shown in FIG. 3, to a turbine outlet of a gas turbine engine, e.g., the turbine outlet 154 of the gas turbine engine 100 shown in FIG. 2. In block 704, the method 700 includes extending a fluid conduit, e.g., the fluid conduit 164 shown in FIG. 2, through a sidewall, e.g., the sidewall 156 shown in FIG. 2, of a tubular section, e.g., the tubular section 150 shown in FIG. 2, of the exhaust system. In block 706, the method 700 includes attaching a nozzle, e.g., the nozzle 162 shown in FIG. 2, to a distal end of the fluid conduit, such that the nozzle is configured to discharge a pressurized fluid into a flow path of the tubular section. In block 708, the method 700 includes attaching the fluid conduit to a source of pressurized air, e.g., a load compressor and/or a compressor of the associated gas turbine engine. The nozzle, conduit, and/or other associated components can be configured such that a stream of pressurized fluid/gas can be selectively introduced into the flow path of the exhaust system to thereby generate a pressure drop in the exhaust system that can be used for the purposes described herein.

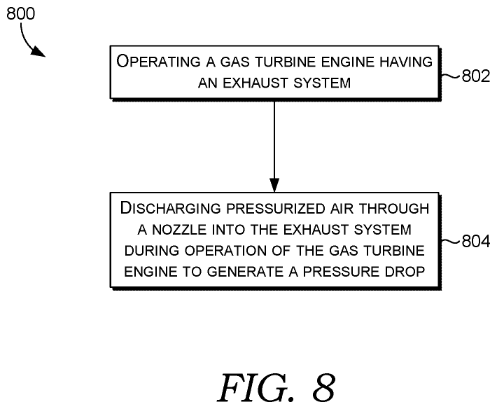

Looking now at FIG. 8, a block diagram of a method 800 of operating a gas turbine engine, e.g., the gas turbine engine 100 shown in FIG. 1, with an exhaust system, e.g., either of the exhaust systems 160 or 178 shown in FIGS. 2 and 3, is provided, according to embodiments of the present disclosure. The method 800 includes blocks 802-804, but is not limited to this selection of elements or the order depicted. In block 802, the method 800 includes operating a gas turbine engine having an exhaust system, e.g., either of the exhaust systems 160 or 178 shown in FIGS. 2 and 3. In block 804, the method 800 includes discharging pressurized air through a nozzle, e.g., the nozzle 162 or 236 shown in FIGS. 2 and 3, into the exhaust system during operation of the gas turbine engine to generate a pressure drop.

Clause 1. An exhaust system for a gas turbine engine, comprising: an inlet; an outlet; a tubular section extending between the inlet and the outlet, wherein the inlet is configured to be attached to a turbine outlet of a gas turbine engine, allowing exhaust gases discharged from the turbine outlet to pass into the tubular section; and a nozzle positioned in the tubular section and configured to discharge a pressurized fluid into a flow path of the exhaust system to generate a pressure drop.

Clause 2. The exhaust system of clause 1, wherein the pressurized fluid is compressed air, and wherein the nozzle is coupled to a fluid conduit that is configured to extend to a source of the compressed air.

Clause 3. The exhaust system of clause 1 or 2, wherein the source of compressed air is a compressor that is adapted to supply the compressed air to at least one other component of the gas turbine engine.

Clause 4. The exhaust system of any of clauses 1-3, wherein the fluid conduit extends through a sidewall of the tubular section.

Clause 5. The exhaust system of any of clauses 1-4, wherein the nozzle is oriented perpendicular to the fluid conduit within the tubular section.

Clause 6. The exhaust system of any of clauses 1-5, wherein the nozzle is axially aligned with the fluid conduit within the tubular section.

Clause 7. The exhaust system of any of clauses 1-6, wherein the nozzle comprises a Venturi-effect nozzle.

Clause 8. The exhaust system of any of clauses 1-7, wherein a diameter of the tubular section is reduced along a length of the tubular section located between the inlet and the outlet.

Clause 9. The exhaust system of any of clauses 1-8, wherein the length is located downstream of the nozzle.

Clause 10. A gas turbine engine, comprising: a compressor; a combustor; a turbine with a turbine outlet; and an exhaust system, comprising: an inlet, an outlet, a tubular section extending between the inlet and the outlet, wherein the inlet is attached to the turbine outlet, allowing exhaust gases discharged from the turbine outlet to pass into the tubular section, and a nozzle positioned in the tubular section and configured to discharge a pressurized fluid into a flow path of the exhaust system to generate a pressure drop.

Clause 11. The gas turbine engine of clause 10, wherein the pressurized fluid is compressed air, and wherein the nozzle is coupled to a fluid conduit that extends to a source of the compressed air.

Clause 12. The gas turbine engine of clause 10 or 11, wherein the fluid conduit extends through a sidewall of the tubular section.

Clause 13. The gas turbine engine of any of clauses 10-12, wherein the tubular section comprises a first section extending from the inlet of the exhaust system, a second section extending from the first section, and a third section extending from the second section and to the outlet of the exhaust system.

Clause 14. The gas turbine engine of any of clauses 10-13, wherein a diameter of the second section is smaller than a diameter of each of the first section and the third section.

Clause 15. The gas turbine engine of any of clauses 10-14, wherein the first section extends along a first axial direction, and wherein the second section and the third section extend along a second axial direction that is perpendicular to the first axial direction.

Clause 16. The gas turbine engine of any of clauses 10-15, wherein the nozzle is oriented to discharge along the second axial direction.

Clause 17. A method of modifying a gas turbine engine to allow for selective generation of a pressure drop, the method comprising: attaching an exhaust system to a turbine outlet of the gas turbine engine, the exhaust system comprising: an inlet, an outlet, and a tubular section extending between the inlet and the outlet, wherein the inlet is attached to the turbine outlet of the gas turbine engine, allowing exhaust gases discharged from the turbine outlet to pass into the tubular section; extending a fluid conduit through a sidewall of the tubular section; attaching a nozzle to the fluid conduit, such that the nozzle is configured to discharge into a flow path of the tubular section to generate a pressure drop; and attaching the fluid conduit to a source of pressurized air.

Clause 18. The method of clause 17, wherein the nozzle is a Venturi-effect nozzle, and wherein the source of pressurized air is a compressor that supplies the pressurized air to multiple components of the gas turbine engine.

Clause 19. The method of clause 17 or 18, wherein the tubular section is substantially linear between the inlet and the outlet, and wherein the tubular section includes a reduced diameter between the inlet and the outlet.

Clause 20. The method of any of clauses 17-19, wherein the tubular section is non-linear between the inlet and the outlet, and wherein the tubular section includes a reduced diameter between the inlet and the outlet.

In aspects and embodiments herein, this disclosure may include the language, for example, “at least one of [element A] and [element B].” This language may refer to one or more of the elements. For example, “at least one of A and B” may refer to “A,” “B,” or “A and B.” In other words, “at least one of A and B” may refer to “at least one of A and at least one of B,” or “at least either A or B.” In aspects and embodiments herein, this disclosure may include the language, for example, “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements. In addition, this disclosure may use the term “a” (element) or “the” (element). This language may refer to the referenced element in the singular or in the plural and is not intended to be limiting in this respect.

The subject matter of this disclosure has been described in relation to particular aspects, which are intended in all respects to be illustrative rather than restrictive. In this sense, alternative aspects will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

1. An exhaust system for a gas turbine engine, comprising:
an inlet;
an outlet;
a tubular section extending between the inlet and the outlet, wherein the inlet is configured to be attached to a turbine outlet of the gas turbine engine, allowing exhaust gases discharged from the turbine outlet to pass into the tubular section; and
a nozzle positioned in the tubular section and configured to discharge a pressurized fluid into a flow path of the exhaust system to generate a controlled pressure drop in the gas turbine engine.

2. The exhaust system of claim 1, wherein the pressurized fluid is compressed air or pressurized steam, and wherein the nozzle is coupled to a fluid conduit that is configured to extend to a source of the pressurized fluid.

3. The exhaust system of claim 2, wherein the source of compressed air is a compressor that is adapted to supply the compressed air to at least one other component of the gas turbine engine.

4. The exhaust system of claim 2, wherein the source of pressurized steam is a steam boiler that is adapted to supply the pressurized steam to at least one other component of the gas turbine engine.

5. The exhaust system of claim 2, wherein the fluid conduit extends through a sidewall of the tubular section.

6. The exhaust system of claim 4, wherein the nozzle is oriented perpendicular to the fluid conduit within the tubular section.

7. The exhaust system of claim 4, wherein the nozzle is axially aligned with the fluid conduit within the tubular section.

8. The exhaust system of claim 1, wherein the nozzle comprises a Venturi-effect nozzle.

9. The exhaust system of claim 1, wherein a diameter of the tubular section is reduced along a length of the tubular section between the inlet and the outlet.

10. The exhaust system of claim 9, wherein the length is located downstream of the nozzle.

11. A gas turbine engine, comprising:
a compressor;
a combustor;
a turbine with a turbine outlet; and
an exhaust system, comprising:
an inlet;
an outlet;
a tubular section extending between the inlet and the outlet, wherein the inlet is attached to the turbine outlet, allowing exhaust gases discharged from the turbine outlet to pass into the tubular section; and
a nozzle positioned in the tubular section and configured to discharge a pressurized fluid into a flow path of the exhaust system to generate a controlled pressure drop in the gas turbine engine.

12. The gas turbine engine of claim 11, wherein the pressurized fluid is compressed air, and wherein the nozzle is coupled to a fluid conduit that extends to a source of the compressed air.

13. The gas turbine engine of claim 12, wherein the fluid conduit extends through a sidewall of the tubular section.

14. The gas turbine engine of claim 11, wherein the tubular section comprises a first section extending from the inlet of the exhaust system, a second section extending from the first section, and a third section extending from the second section and to the outlet of the exhaust system.

15. The gas turbine engine of claim 14, wherein a diameter of the second section is smaller than a diameter of each of the first section and the third section.

16. The gas turbine engine of claim 14, wherein the first section extends along a first axial direction, and wherein the second section and the third section extend along a second axial direction that is perpendicular to the first axial direction.

17. The gas turbine engine of claim 16, wherein the nozzle is oriented to discharge along the second axial direction.

18. A method of modifying a gas turbine engine to allow for selective generation of a pressure drop, the method comprising:
attaching an exhaust system to a turbine outlet of the gas turbine engine, the exhaust system comprising:
an inlet;
an outlet; and
a tubular section extending between the inlet and the outlet, wherein the inlet is attached to the turbine outlet of the gas turbine engine, allowing exhaust gases discharged from the turbine outlet to pass into the tubular section;
extending a fluid conduit through a sidewall of the tubular section;
attaching a nozzle to the fluid conduit, such that the nozzle is configured to discharge into a flow path of the tubular section to generate a controlled pressure drop in the gas turbine engine; and
attaching the fluid conduit to a source of pressurized air.

19. The method of claim 18, wherein the nozzle is a Venturi-effect nozzle, and wherein the source of pressurized air is a compressor that supplies the pressurized air to multiple components of the gas turbine engine.

20. The method of claim 18, wherein the tubular section is substantially linear between the inlet and the outlet, and wherein the tubular section includes a reduced diameter between the inlet and the outlet.

21. The method of claim 18, wherein the tubular section is non-linear between the inlet and the outlet, and wherein the tubular section includes a reduced diameter between the inlet and the outlet.
